(19) United States
(12) Patent Application Publication
(10) Pub. No.: US 2005/0180743 A1
(43) Pub. Date: Aug. 18, 2005

(54) Exposure device

(75) Inventor: Pochih Chen, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/037,844

(22) Filed: Jan. 18, 2005

(30) Foreign Application Priority Data
Jan. 30, 2004 (TW) TW93201370

(51) Int. Cl. G03B 9/08

(52) U.S. Cl. 396/463

(57) ABSTRACT

An exposure device for a camera comprises a lens, a shutter, a base and a driving device, wherein the shutter is driven by the driver to move on the base. Shutter movement is kept inline by a track formed by a first restraining member and a second restraining member. Thereby, the shutter can block or admit incident light through the lens.

### BACKGROUND OF THE INVENTION

1. Field of the Invention

The present invention relates to an exposure device for a camera, and in particular to an exposure device provided with an inline shutter.

2. Description of the Related Art

Digital cameras are generally required to be compact and light. The lens assembly of a digital camera normally comprises a lens, a shutter and a diaphragm. To minimize volume, while maintaining optical quality, space occupied by the shutter and the diaphragm must be minimized.

Shutters in conventional digital cameras provided with fixed focus comprise single or multiple rotatable shutter blades. In the shutter shown in FIG. 1, a single shutter blade 20 rotates around a shaft 40, acting as a lever by a driver 30 blocks or admits incident light.

The shutter with multiple shutter blades uses a specific mechanism linked to the blades to provide simultaneous rotation. Because the multiple shutter blades move a shorter distance than the single shutter blade, a faster shutter movement is obtained. However a complicated structure is required.

In the single shutter blade structure, a space as large as the diameter of the lens must be reserved for the shutter blade, such that the lens assembly still occupies considerable space.

### SUMMARY OF THE INVENTION

Accordingly, an object of the invention is to provide an exposure device with simple structure occupying less space.

The invention accordingly provides an exposure device comprising a lens, a shutter disposed in one side of the lens, a base bearing the shutter and a driver for the shutter, wherein the shutter moves on the base, aligning with the lens selectively for image capture. The shutter is disposed behind the lens and has an aperture selectively aligned therewith. The driver comprises a solenoid valve having a finger entering an opening of the shutter. The base comprises first and second restraining members disposed respectively on both sides of the shutter track to maintain inline shutter action.

The shutter comprises a first shutter blade having a first aperture disposed behind the lens and a second shutter blade having a second aperture disposed behind the first shutter blade. The driver comprises a first solenoid valve moving the first shutter blade inline, aligning the first aperture aligned with the lens selectively, and a second solenoid valve moving the second shutter blade inline, aligning the second aperture with the lens selectively. The first shutter blade moves in alignment with the second shutter blade but in an opposite direction. The base comprises a first post and a second post disposed respectively on both sides of the first shutter blade track to guide inline movement of the first shutter blade. The base further comprises a third post and a fourth post disposed respectively on the both sides of the second shutter blade track to guide the second shutter blade moving inline. The diameter of the first aperture exceeds the diameter of the second aperture.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional shutter device as referenced in the Related Art;

FIG. 2 is a perspective view of an exposure device (shutter device) of the invention;

FIG. 3 is an exploded perspective view of the exposure device of the invention; and

FIG. 4 is a schematic view of the exposure device of the invention showing the movement of the shutter blade.

### DETAILED DESCRIPTION OF THE INVENTION

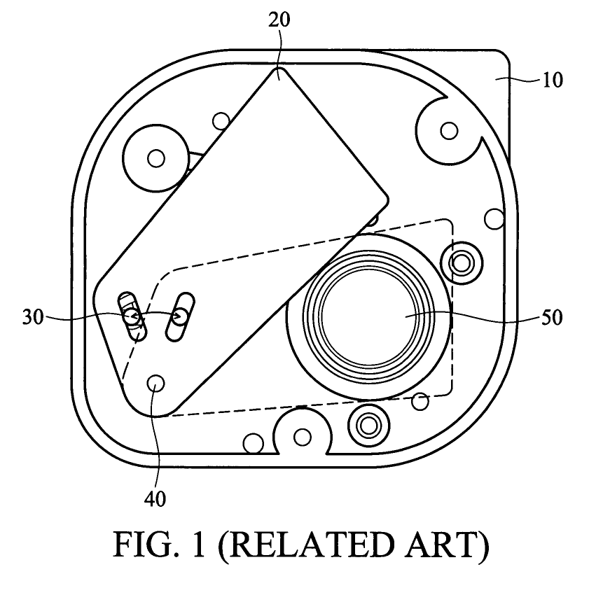

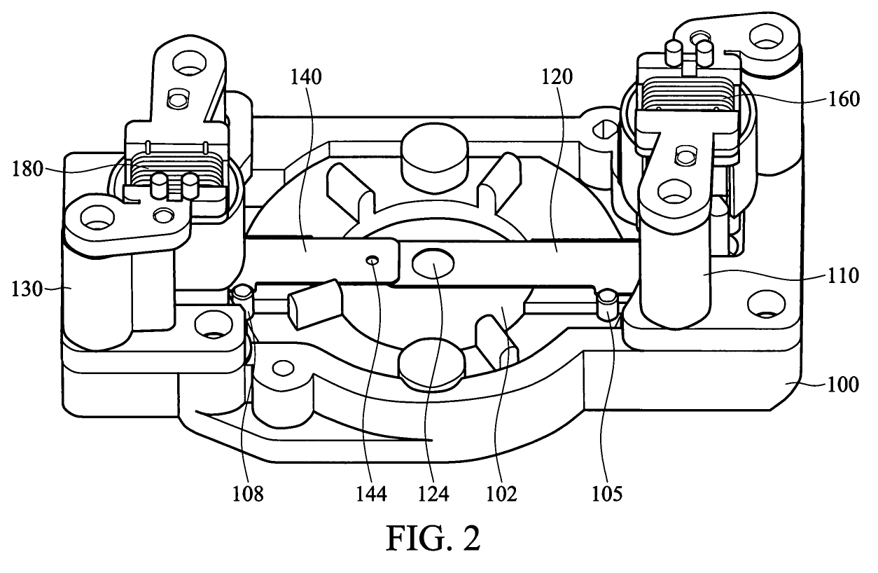

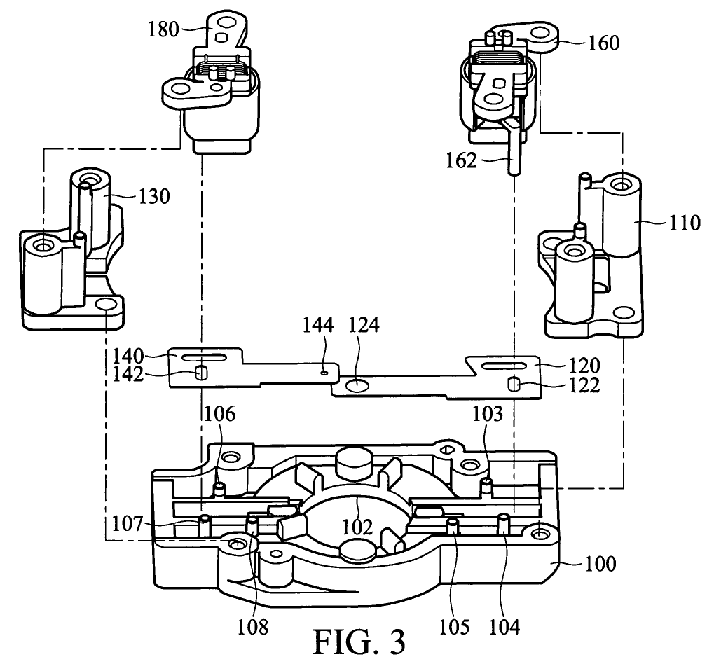

FIG. 2 is a perspective view of the exposure device of the invention. FIG. 3 is an exploded perspective view of the exposure device of the invention. As shown in FIGS. 2 and 3, a first solenoid valve 160 and a second solenoid valve 180 are mounted on a first solenoid valve seat 110 and a second solenoid valve seat 130 on a base 100 of a camera respectively. A finger 162 of the first solenoid valve 160 enters in an opening 122 of a first shutter blade 120 to move the first shutter blade 120, and the first shutter blade 120 is guided by posts (restraining members) 103, 104, 105 on the base 100 to move inline. A finger (not shown) of the second solenoid valve 180 enters in an opening 142 on a second shutter blade (acting as a diaphragm) 140 to move the second shutter blade 140, and the second shutter blade 140 is guided by posts 106, 107, 108 on the base 100 to move inline. As shown in FIG. 1, movement of the first shutter blade 120 is aligned with the second shutter blade 140 but in an opposite direction.

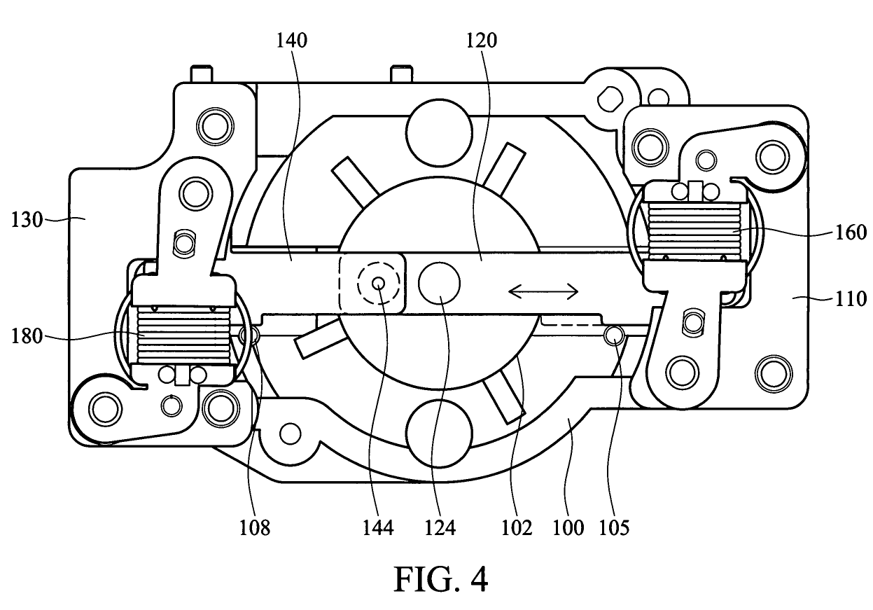

FIG. 4 shows the movement of the first shutter blade 120. As shown in FIG. 4, the first shutter blade 120 has a first aperture 124. The finger 162 swings to move the first shutter blade 120 back and forth. When the first aperture 124 moves to the center of an opening 102 of the base 100, the first aperture 124 aligns with the lens (not shown) of the camera to admit incident light, forming an image on a film or a charge-coupled device. The second shutter blade 140 also has a second aperture 144. The finger of the second solenoid valve 180 swings to move the second shutter blade 140 back and forth. As the second shutter blade acts as a diaphragm of the camera, when the second aperture 144 moves to the center of the opening 102 to align with the lens, less incident light is admitted.

As the first and second shutter blades move inline, i.e. the tracks of the first and second shutter blades are overlapped to reduce space required for shutter movement. Thereby, the size of the digital camera can be reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An exposure device for a camera, comprising:
a lens;
a shutter disposed adjacent to the lens;
a base bearing the shutter; and
a driver for the shutter;
wherein the shutter is capable of moving inline on the base, selectively blocking or admitting incident light passing through the lens.

2. The exposure device as claimed in claim 1, wherein the shutter is disposed behind the lens.

3. The exposure device as claimed in claim 1, wherein the shutter has an aperture selectively aligned with the lens.

4. The exposure device as claimed in claim 1, wherein the driver comprises a solenoid valve.

5. The exposure device as claimed in claim 4, wherein the shutter has an opening for the solenoid valve moving the shutter.

6. The exposure device as claimed in claim 5, wherein the solenoid valve comprises a finger entering the opening to move the shutter.

7. The exposure device as claimed in claim 1, wherein the base comprises a first restraining member and a second restraining member disposed respectively on both sides of the shutter track guiding the shutter to move inline.

8. The exposure device as claimed in claim 1, wherein the shutter comprises a first shutter blade having a first aperture disposed behind the lens and a second shutter blade having a second aperture disposed behind the first shutter blade; the driver comprises a first solenoid valve moving the first shutter blade inline to align the first aperture with the lens selectively and a second solenoid valve moving the second shutter blade inline to align the second aperture with the lens selectively.

9. The exposure device as claimed in claim 8, wherein movement of the first shutter blade is aligned with the second shutter blade.

10. The exposure device as claimed in claim 9, wherein the first shutter blade moves in an opposite direction to the second shutter blade.

11. The exposure device as claimed in claim 8, wherein the base comprises a first post and a second post disposed respectively on the both sides of the first shutter blade track guiding the first shutter blade to move inline.

12. The exposure device as claimed in claim 11, wherein the base further comprises a third post and a fourth post disposed respectively on both sides of the second shutter blade track guiding the second shutter blade to move inline.

13. The exposure device as claimed in claim 8, wherein the diameter of the first aperture is larger than the diameter of the second aperture.
